(19) United States
(12) Patent Application Publication
(10) Pub. No.: US 2014/0165845 A1
(43) Pub. Date: Jun. 19, 2014

(54) HOT BEVERAGE PREPARATION DEVICE

(71) Applicant: Ravinder Issar, Esslingen (DE)

(72) Inventor: Ravinder Issar, Esslingen (DE)

(21) Appl. No.: 13/980,961

(22) PCT Filed: Jan. 24, 2012
(86) PCT No.: PCT/EP2012/000298

§ 371 Date: Dec. 23, 2013

(30) Foreign Application Priority Data
Jan. 26, 2011 (DE) 10 2011 009 429.6

(51) Int. Cl. A47J 31/20

(52) U.S. Cl. CPC A47J 31/20
USPC 99/283; 99/287

(57) ABSTRACT

The invention relates to a hot beverage preparation device for household- or gastronomic needs, comprising a heating device (3; 403) for the liquid, a control device (4) for actuating the heating device (3; 403), and a beverage container (5; 305; 405) which is configured for accommodating the heated liquid, wherein a stiffing unit (6; 106; 406) is disposed in the beverage container (5; 305; 405), the stirring unit is configured for a stirring movement of the heated liquid in order to facilitate a homogeneous distribution of a beverage substrate that can be introduced in the heated liquid, In accordance with the invention, it is provided that a storage container (2) for a liquid is provided, particularly disposed in a housing (28), and/or that the stirring device (6; 106) comprises a filtering device (206; 486) for accommodating the beverage substrate.

### CROSS-REFERENCE TO RELATED APPLICATIONS

This application is an U.S. national phase application under 35 U.S.C. §371 based upon co-pending International Application No. PCT/EP2012/000298 filed on Jan. 24, 2012. Additionally, this U.S. national phase application claims the benefit of priority of co-pending International Application No. PCT/EP2012/000298 filed on Jan. 24, 2012 and German Application No. 10 2011 009 429.6 filed on Jan. 26, 2011. The entire disclosures of the prior applications are incorporated herein by reference. The international application was published on Aug. 2, 2012 under Publication No. WO 2012/100934 A1.

### BACKGROUND OF THE INVENTION

1. Field of the Invention

The invention relates to a hot beverage preparation device for household- or gastronomic needs, having a heating device for the liquid, a control device for actuating the heating device and a beverage container, which is configured for receiving the heated liquid, wherein a stifling device is disposed in the beverage container, which is configured for a stifling movement of the heated liquid, in order to facilitate a homogenous distribution of beverage substrate which can be introduced in the heated liquid.

2. Description of the Prior Art

A tea machine for the preparation of tea is known from the document DE 20 2006 016 849 U1, which includes a storage tank for tea leaves, a portioning device for tea leaves, a heating element for heating water and a vessel for receiving the portioned tea leaves and water.

### SUMMARY OF THE INVENTION

The object underlying the invention consists of providing a hot beverage preparation device, which facilitates a simplified beverage preparation.

This object for a hot beverage preparation device of the type mentioned above, is achieved by the features of the claims. Here, it is provided that a storage tank for a liquid is provided, particularly disposed in a housing, and/or that the stirring device includes a filtering device for receiving the beverage substrate.

The storage tank allows to store a greater liquid quantity, particularly water, than it is necessary for the preparation of a portion of the hot beverage that can be received in the beverage container. In this way, several portions of the hot beverage can be prepared without intermittent liquid supply.

By means of the stirring device, which includes a filtering device for receiving the beverage substrate, the beverage substrate, in which, for example- tea leaves and/or coffee powder and/or spices and/or cocoa and/or sugar may be brought in a particularly intensive exchange with the liquid received in the beverage container, so that if necessary, a quicker preparation of the hot beverage can be achieved and/or a smaller quantity of the beverage substrate may be sufficient for achieving the desired intensity of flavor as compared with the conventional hot beverage preparation. In addition, the stirring movement and thereby even the relative movement between the beverage substrate and the liquid received in the filtering device depending on the selected relative speed between the stirring device and the liquid can be used for the purpose of either reducing or preventing an undesired foaming of the heated liquid or alternatively also causing a possible desired foaming of the liquid in suitable liquids. Another effect of the stirring device consists of that the liquid in the region of the bottom of the beverage container, which serves for the heat transmission into the liquid according to the configuration of the heating device, a local overheating of the liquid is avoided. Such a local overheating, on the one hand may lead to an impairment of the flavor of the prepared hot beverage, on the other hand, an undesired sticking or burning of the liquid at the bottom of the beverage container may take place. Both the effects are at least minimized or even completely prevented by the stifling device. In an advantageous embodiment of the invention, an automated supply of liquid and/or beverage substrate from the storage tank can take place into the beverage container even during the stifling process.

Advantageous embodiments of the invention are the subject matter of the subordinate claims.

It is useful, if the stirring device includes a driving device disposed outside the beverage container and coupled to the control device. Preferably, the driving device is configured as an electrical motor, which is supplied with electrical energy by the control device. Preferably, the supply of the driving device with electrical energy takes place depending on other control- or regulation processes continuing in the control device, particularly depending on the actuation of the heating device by the control device. The driving device can be configured for a direct coupling of an exclusively rotational movement on a stirring means. By the interconnection of a gear transmission, even the interaction of several rotational movements can be provided about the rotational- and/or pivoting axis which are coaxial with respect to each other or angularly oriented with respect to each other. Alternatively, the driving device is configured for providing a linear movement or for the interaction between a linear and a rotatory movement.

In an embodiment of the invention, it is provided that the stirring device includes a telescopic shaft section connected to the driving device, which is configured for a height adjustment of the stirring means which can be disposed in the beverage container. Because of this, the stirring means which is coupled to the driving device and is moved by this in the stifling movement, for example, displaced between an operational position deeply immersed in the container volume confined by the beverage container and will be displaced from a rest position away from the container volume. In the operational position, an effective stifling process for the liquid is ensured in the beverage container; in the rest position, the beverage container can be removed from the hot beverage preparation device in a simple manner, for example, in order to serve the prepared hot beverage or to clean the beverage container.

It is advantageous, if the stifling device includes a coupling device, which is configured for a contactless power transmission between the driving device and a stirring means disposed in the beverage container. As a result, the beverage container can be removed from the hot beverage preparation device, without requiring the stifling device to be first brought from an operational position to a rest position. Preferably, the coupling device is configured as a magnetic coupling, for example, in the form of a first permanent magnet, which is set in motion by the driving device and in the form of a second permanent magnet, which is a constituent of the stirring device and which follows the movement of the first permanent magnet. Particularly preferably, the driving device is disposed in a region under the bottom of the beverage container and the permanent magnets are adjusted on each other such that because of this, the magnetic coupling between the driving device and the stirring device is also ensured through the bottom of the beverage container. Here, it is advantageous if the beverage container is manufactured from a non-magnetisible material, particularly from glass.

Preferably, a filtering device configured to be liquid permeable, at least in sections, is disposed in the beverage container, which is configured such that the filtering device has a restraining function for the beverage substrate and which facilitates a distribution of the flavoring agents of the beverage substrate in the heated liquid. As a filtering device, for example, a pouch made of filter paper, preferably realized as a closed pouch can be employed, in which beverage substrate is accommodated. Alternatively, the filtering device is configured as permanent filter, which is provided for a multiple use and which is manufactured, for example, from a perforated, thin-walled metallic sheet or from a perforated or porous plastic. Therefore, the size of the holes or pores in the material of the filtering device is selected such that an intensive exchange of flavor is ensured between the beverage substrate and the heated liquid, while non-soluble constituents of the beverage substrate cannot escape out through the holes or pores of the filtering device into the heated liquid.

In a further configuration of the invention, the stirring device is configured as receptor for the filtering device realized to be interchangeable. In this way, the filtering device can be filled with the beverage substrate away from the hot beverage preparation device and subsequently, it can be coupled to the stifling device. Exemplarily, the filtering device is configured as a filter bag made of filter paper, wherein the beverage substrate is filled inside the filter bag and subsequently, the filter bag is fixed on the stifling device. For this purpose, the stifling device can be provided, for example, with retaining clamps, which if necessary, also ensure a safe closure of the filling opening of the filter bag. By mounting of the filtering device on the stirring device, a particularly intensive intermixing of the heated liquid with the beverage substrate is achieved, so that a shortening of the process of preparation and/or a reduction in the use of the beverage substrate, particularly without any loss of quality in the prepared hot beverage, can be achieved.

It is useful, if the filtering device is integrated in the stirring device. As a result, a simple operation of the hot beverage preparation device can be ensured, because a secured connection between the stirring device and the filtering device is always guaranteed.

In an advantageous embodiment of the invention it is provided that a filling opening of the filtering device is disposed above a predeterminable maximum liquid level of the beverage container for the supply of beverage substrate, particularly in order to facilitate the supply of beverage substrate during the process of beverage preparation. In such an arrangement of the filling opening, on the one hand, it is ensured that floating constituents of the beverage substrate, for example, tea leaves do not reach the heated liquid during the stifling process into the beverage preparation and on the other hand, even during the stirring process or in pauses between stirring processes, a simple and easily manageable supply of beverage substrate can take place. It is preferred that the filling opening of the filtering device is configured rotationally symmetrical with respect to the axis of rotation of the stifling device, so that the supply of the beverage substrate into the filtering device can take place even during the operation of the stirring device. This is then significant, for example, when the beverage substrate includes several different constituents, which should be supplied into the filtering device at a chronological sequence during the beverage preparation process.

It is advantageous, if the control device is configured such that the heating of the liquid in the beverage container takes place by means of a predeterminable temperature profile and/or that the operation of the stirring device takes place depending on the supply and/or the temperature and/or the filling level of the liquid. For example, it is necessary during the preparation of many hot beverages such as Indian tea, to bring the liquid provided with the beverage substrate to boil several times and to allow them to cool again in order to achieve the desired extraction of the flavoring agents from the beverage substrate. In the same manner, it may be advantageous that to operate the stirring device with a different speed, particularly higher speed during one or more warming-up phases of the liquid, than in the intermediate cooling phases. It is particularly advantageous, if an input means and control unit is associated with the control device, particularly with an indicating device by means of which the desired temperature- and/or stifling profile can be selected and if necessary, changed. Complimentarily or alternatively, it can be provided to actuate the stirring device and/or the heating device such that a process of beverage preparation for the hot beverage is started only then when the filling level sensor detects a sufficient filling level in the beverage container.

In a further configuration of the invention, it is provided that a feeding device for another liquid, particularly milk, includes a storage tank and/or a conveying means and/or a metering valve and is configured for feeding the liquid into the beverage container. In this way, the feeding device facilitates an automated feeding of the second liquid, preferably depending on the progress of preparation of the hot beverage, wherein the feeding can be adjusted in view of the point of time and/or on the metering quantity for the second liquid, particularly by means of the control device. The second liquid can be conveyed from an original unopened container, for example a milk carton, into the beverage container by means of a pipe and if necessary, by means of a conveying means. Complimentarily or alternatively, a second storage tank can be provided as a constituent of the hot beverage preparation device, in which the second liquid is stored. The feeding of the second liquid can be extremely precisely adjusted by means of a metering valve, particularly coupled to the control device.

Preferably, for monitoring the liquid level in the beverage container, a liquid level sensor is provided, which is connected to the control device in order to control liquid feeding and/or the liquid outflow and/or the heat supply to the beverage container and/or the stifling speed of the stirring device. For this purpose, the liquid level sensor is employed to monitor the filling of the beverage container at the start and/or during execution of the process of beverage preparation and to effect and/or stop the liquid feeding by means of the control device. In addition, the liquid level sensor can be employed for the purpose of monitoring the liquid level in the beverage container during the process of beverage preparation, for example, during the foaming of the liquid by changing the stirring speed of the stirring device and/or by changing the heat output of the heating device and/or by feeding liquid, for example, a second liquid, in order to avoid a further foaming of the hot beverage. The liquid level sensor can also be configured as an optical sensor, particularly as optically transmissive or reflective sensor, by which a contactless monitoring of the liquid level is facilitated.

Preferably, two liquid level sensors linearly spaced apart from each other along the axis of rotation and/or a temperature sensor are provided, particularly on the stirring device and/or in the beverage container. By means of at least two liquid level sensors, it can be determined whether the minimum level of the liquid is present in the beverage container and/or whether the maximum level of the liquid is exceeded in the beverage container. In both the cases, the control device can be configured such that it prevents the start of the hot beverage preparation, particularly heating of the liquid. By means of the temperature sensor provided, if necessary, the temperature of the liquid in the beverage container can be monitored or regulated by the control device.

In a further configuration of the invention, a product container is provided for the prepared beverage, wherein a connection line is configured between the beverage container and the product container for feeding the beverage from the beverage container to the product container and wherein a non-return valve coupled to the control device and/or a conveying means coupled to the control device is associated with the connection line. The product container and the associated connection line facilitate an automated draining of the beverage container after carrying out the beverage preparation process, for example, in order to avoid a too long stay of the beverage substrates accommodated in the filtering device in the hot beverage. In addition, the product container can be configured, for example as an insulated vessel for keeping warm, in which the hot beverage does not exceed a predeterminable serving temperature over a longer time period without external heat supply. Preferably, the control device is configured such that the feeding of the prepared hot beverage from the beverage container into the product container at a predeterminable point of time, for example by corresponding actuation of a non-return valve and/or of a conveying means takes place by the control device.

In a further configuration of the invention, it is provided that the control device is configured such that it can perform a sequence of successive heating- and cooling cycles with predeterminable cycle duration and/or predeterminable target temperatures for a heating cycle and a cooling cycle by means of the heating device or the heating device and the stirring device. Therefore, it can be provided that a user of the hot beverage preparation device can specify the number of the heating- and cooling cycles and/or the duration of these cycles and/or the target temperatures for the respective cycles. Alternatively, it can be provided that the cycle number, duration and target temperatures are permanently programmed in the control device.

### BRIEF DESCRIPTION OF THE DRAWINGS

Advantageous embodiments of the invention are represented in the drawings. In this connection:

FIG. 1 shows a schematic representation of a first embodiment of the hot beverage preparation device,

FIG. 2 shows a sectional representation of a second embodiment of a hot beverage preparation device,

FIG. 3 shows a perspective representation of the filtering device,

FIG. 4 shows a front view and a side view of a stirring means, which is configured for accommodating a filtering device,

FIG. 5 shows a schematic representation of a third embodiment of the hot beverage preparation device,

FIG. 6 shows a schematic representation of a fourth embodiment of the hot beverage preparation device in an operational position, and

FIG. 7 shows the hot beverage preparation device according to FIG. 6 in a maintenance position.

### DETAILED DESCRIPTION OF THE INVENTION

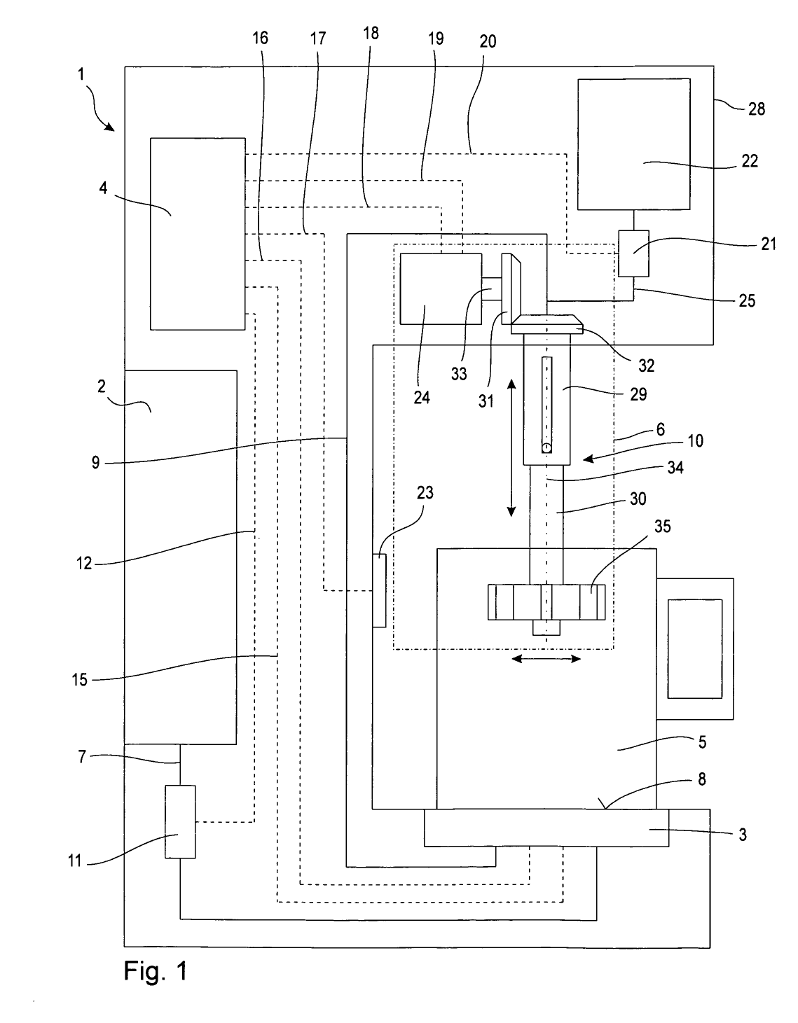

A hot beverage preparation device 1 schematically represented in the FIG. 1 includes a storage tank 2, a heating device 3, a control device 4, a beverage container 5 and a stirring device 6. The storage tank 2 is configured for receiving a first liquid, particularly water and remains in fluidically communicating connection with the heating device 3 via a first fluid line 7. The heating device is exemplarily configured as a heating coil with integrated water channel for a flow heater of the liquid provided from the storage tank 2 and for heating of the bottom region 8 of the beverage container 5. The liquid heated in the heating device 3 is lead into the beverage container 5 via a second fluid line 9 configured as a riser pipe. Exemplarily, the second fluid line is lead, section by section, through one of the stirring means 10 associated with the stifling device 6.

In the first fluid line 7, a non-return valve 11 is disposed between the storage tank 2 and the heating device 3, which is configured for releasing or blocking the fluid flow from the storage tank 2 into the heating device 3 and thereby into the beverage container 5. The non-return valve 11 remains in electrical communication with the control device 4 via a control wire 12 and as a result, can be switched between the release state and the locked state by the control device by means of a corresponding control signal.

The control device 4 exemplarily remains in electrically communicating connection with the heating device 3 via further control wires 15 to 20, in order to provide the electrical energy necessary for heating the liquid, with a liquid level sensor 23 which is provided for monitoring the liquid level in the beverage container, provided with a stifling device 6 electrical motor 24 and with a non-return valve 21 which is coupled to a third fluid line 25, which extends between a second storage tank 22 and the second fluid line 9.

Preferably, all the above mentioned components with the exception of the beverage container 5 are disposed in and if necessary, on a common housing 28. Apart from the motor 24, the stifling device 6 includes the stirring device 10 which is exemplarily configured telescopic. The stifling device 10 includes a shaft 29 rotatably mounted in the housing 28 and a stirrer 30 mounted on the shaft 29 in a non-rotational and linearly displaceable manner. Preferably, latching means - not represented in more details - are provided which latch into the stirrer 30 in the represented operational position and/or in an approximately rest position on the shaft 29 and in this way, ensure a defined positioning of the stirrer 30 during the stirring process and/or during the removal of the beverage container 5. Exemplarily, between the electrical motor 24 and the rotatably mounted shaft 29, an angular gear transmission is configured, which includes a first bevel gear 31 non-rotationally connected to the motor shaft 33 of the electrical motor 24 and a second bevel gear 32 non-rotationally connected to the shaft 29.

In the shaft 29 and in the stirrer 30, a channel- not represented- is provided, preferably configured concentric with respect to the axis of rotation 34, through which the second fluid line 9 is lead and which flows out on one of the lower end face of the stirrer 30, which is located opposite the bottom region 8 of the beverage container 5. By this arrangement of the second fluid line 9, even during the rotation of the stirrer 30 about the axis of rotation 34, a harmless automated feeding of liquid can take place from the first storage tank 2 and/or from the second storage tank 22. The monitoring of the filling process of the beverage container 5, effected by the control device 4, takes place by means of the liquid level sensor, which is exemplarily configured as an optical sensor based on the reflective measurement and sends on the surface of the beverage container 5 exemplarily manufactured from glass and evaluates the reflex response depending on the liquid level. In the embodiment of the hot beverage preparation device 1 represented in FIG. 1, the stirrer 30 has several stirring blades 35 protruding in the radial direction perpendicular to the axis of rotation 34. The stirring blades 35 ensure an advantageous intermixing of the liquid accommodated in the beverage container 5 with the beverage substrate interspersed in the liquid.

For the preparation of a hot beverage, for example of an Indian tea, the hot beverage preparation device 1 can exemplarily be operated in the following manner. Initially, after monitoring of the liquid filling level in the first storage tank 2, a temporary release of the non-return valve 11 in the first fluid line 7 and application of the heating device 3 with electrical energy is affected by the control device 4. Because of this, the first liquid, for example which is water, can flow from the storage tank 2 through the first fluid line 7 towards the heating device 3, in order to be heated there and subsequently, to flow through the second fluid line 9 and the stirring device 10 into the beverage container 5. In the beverage container 5, for example, tea leaves and spices are contained as beverage substrate, either in loose form or in a tea bag made of filter paper or a tea sieve made of metal or plastic. After feeding of the liquid quantity predetermined by the control device 4 into the beverage container 5, the non-return valve 11 is closed. The application of the heating device 3 with electrical energy is maintained in order to cause a further heating of the liquid in the beverage container 5 by heat transmission through the bottom region of the beverage container 5. In addition, the stifling device 6 can be activated by providing electrical energy to the electrical motor 24, so that the liquid accommodated in the beverage container 5 is moved in a rotational movement by means of the stirrer blade 35 on the stirrer 30, by which an advantageous intermixing of the liquid and as a result, an effective extraction of the flavoring agents contained in the beverage substrate takes place. After reaching a predeterminable target temperature, which is controlled by the control device 4, either by the time control of the heating process or a temperature regulation by means of a temperature sensor—not represented, particularly in the heating device 3, exemplarily the switching-off of the heating device 3 takes place. Since, the stirring device 6 will be used further, now a cooling of the liquid takes place in the beverage container 5, wherein the cooling process can be influenced by variation in the rotational speed of the electrical motor 24. Subsequently, the second non-return valve 21 can be opened, in order to feed the second liquid, particularly milk from the second storage tank 22 into the beverage container 5 via the third and the second fluid line 25, 9. After the desired quantity of the second liquid was fed into the beverage container 5 and was homogenously distributed in the beverage container 5 by means of the stifling device 6, the hot beverage can be completed by one or multiple heating's and intermediate cooling's of the liquid in the beverage container 5. Therefore, the liquid level sensor 23 can be employed for the purpose of monitoring the foaming of the hot beverage in the beverage container 5 and on exceeding a predeterminable liquid level in the beverage container 5, an increase in the rotational speed of the stifling device 6 and/or a switching-off of the heating device 3 is effected, in order to avoid an overflow of the hot beverage over the upper edge of the beverage container 5. At the end of the process of preparation, an optical and/or acoustic signal can be issued, in order to indicate the availability of the finished hot beverage to the operator. In order to be able to remove the beverage container 5 from the hot beverage preparation device 1 in a simple manner, the stirrer 30 is brought upwards in a not represented rest position by a linear displacement in the vertical direction from the operational position shown in FIG. 1, so that the stirrer 30 is disposed above the edge of the beverage container 5 and the beverage container can be removed in the horizontal direction.

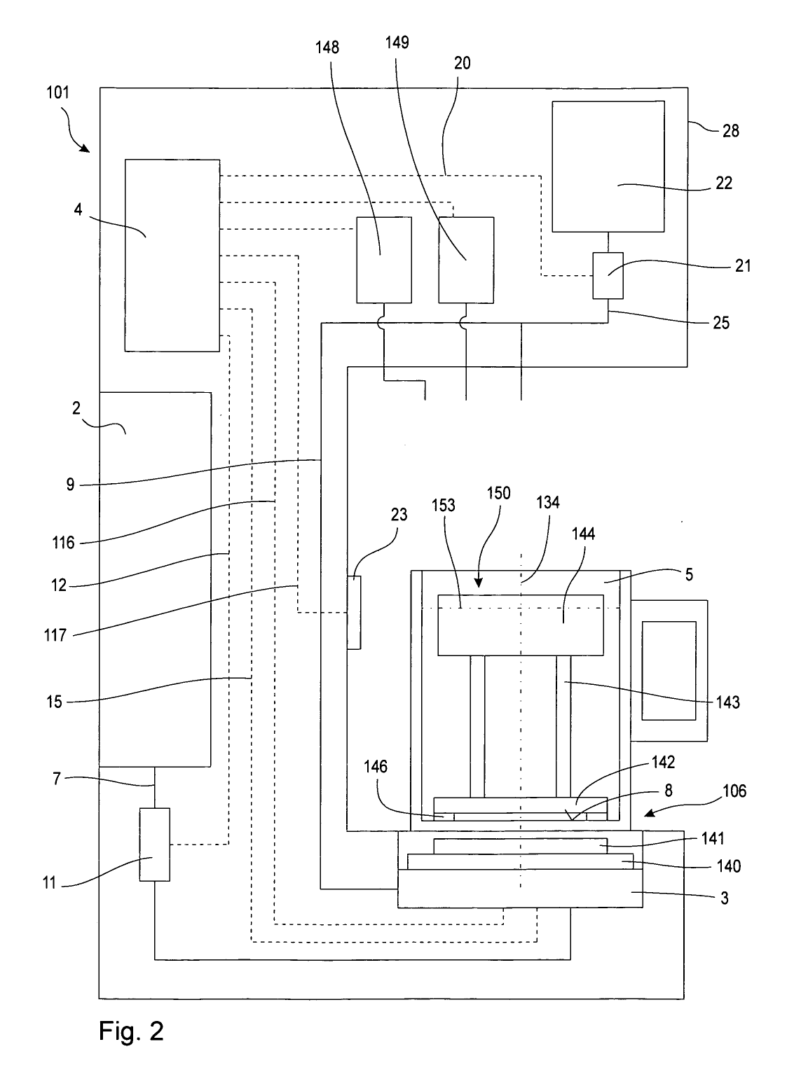

In the embodiment of a hot beverage preparation device 101 represented in FIG. 2, the stirring device 106 is configured as a magnetic stirrer. The remaining construction of the hot beverage preparation device 101 essentially corresponds to the embodiment according to the FIG. 1, so that the same reference numerals are used for functionally similar components.

The stirring device 106 includes a driving motor 140 disposed under the bottom region 8 of the beverage container 5, to which a permanent magnet 141 is associated and a stirrer insert 150 accommodated in the beverage container 5, to which a second permanent magnet 142 is associated. Both the permanent magnets 141, 142 form a magnetic coupling, by which the rotational movement of the driving motor 140 can be transmitted to the stirrer insert 150 in order to effect a rotational movement about the axis of rotation 134. As a result, the stifling device 6 disposed above the beverage container 5 can be dispensed with, by which a distinct design for the hot beverage preparation device 106 according to the second embodiment results as compared with the first embodiment.

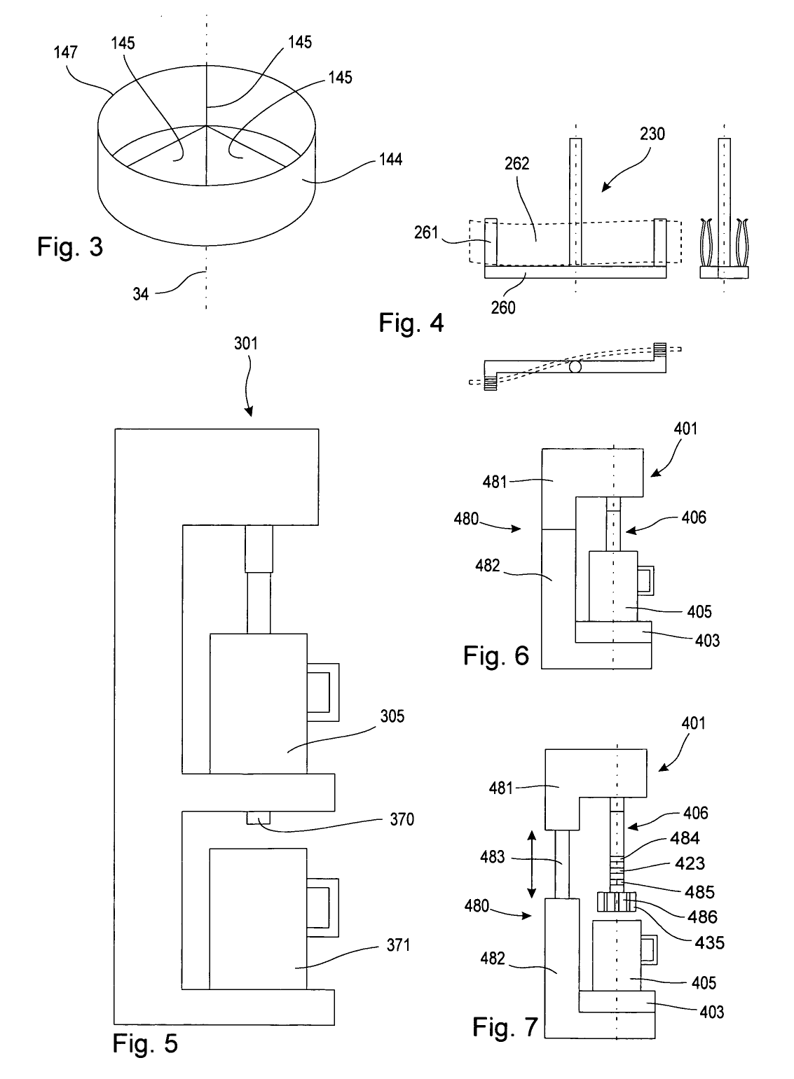

For a good antifriction property of the stirrer insert 150, bearing elements 146, for example made of a plastic material are introduced on the lower side facing the bottom region 8 thereof. The stirrer insert 150 further includes a strainer insert 144, which is coupled to the permanent magnet 142 by means of the supporting columns 143. The strainer insert 144 represented in more details in the FIG. 3, is preferably manufactured from a perforated or porous material, particularly plastic or metal and has an opening 147 oriented upwards in the vertical direction. Since, the stirring device 106 in this embodiment is driven from the lower side of the beverage container 5, the feeding of beverage substrate into the strainer insert 144 can also be carried out during the stirring process. Preferably, the liquid level in the beverage container 5 is adjusted such that it does not exceed the dashed line in the FIG. 2, so that at each point of time, an undesired foaming of beverage substrate from the strainer insert 144 is avoided. In order to ensure the greatest possible exchange surface between the beverage substrate and the liquid which can flow into the strainer insert 144, the strainer insert 144 is provided with several partition walls 145, which preferably extend in the radial direction starting from the center of the strainer insert 144.

The hot beverage preparation device 101 is exemplarily, in addition, provided with two metering devices 148 and 149, which are schematically represented and which respectively have a storage tank and a metering element—not represented in more details, which can be actuated by the control device 4, for example, in the manner of an electromagnetically actuatable slider. The metering devices 148 and 149 can exemplarily be filled with tea and with spices. They are actuated by the control device 4 during the preparation of the hot beverage in such a manner that for example, at first the desired tea quantity is metered into the strainer insert 144 and after a predeterminable time period, a feeding of the spices takes place from the second metering device 149. Therefore, the sequence and the extent of the metering processes can be predefined by the user defined programming. Together with the actuation of the stirring device 106, the heating device 3, the non-return valve 11 and the non-return valve 21, in this way, the preparation of more complex recipes for hot beverages, for example for Indian tea can also be undertaken by the hot beverage preparation device 101 in accordance with the invention. It is advantageous here that the strainer insert 144 is open upwards and the upper edge of the strainer insert 144 lies above the maximum liquid level 153 provided in the beverage container 5. Because of this, the feeding of the constituents of the beverage substrate, that is in particular, the tee leaves and the spices takes place by direct metering from the metering devices 148 and 149 by using the force of gravity and no complex opening and closing of the strainer insert is necessary.

In another embodiment of the stirrer 230 represented in the FIG. 3, essentially this is configured T-shaped, wherein a respective retaining chamber 261 is configured at the end regions of a cross member 260. In the retaining chambers 261, a filter bag 262 can be inserted and fixed, in which the beverage substrate which may include soluble as well as insoluble constituents, is accommodated. By the rotational movement of the stirrer 230 and of the filter bag 262 fixed thereon in the liquid, the desired intensive extraction of the flavors from the beverage substrate in the filter bag 162 is ensured. The stirrer 230 can be employed instead of the stirrer 30 in the stirring device 6 according to the FIG. 1.

The third embodiment of a hot beverage preparation device 301 represented in the FIG. 5, in addition to the components known from the first embodiment of the hot beverage preparation device 1, has one more product container 371, which is disposed below the modified beverage container 305 in contrast to the embodiment according to the FIG. 1. The beverage container 305 has an outlet on the bottom—not represented in more details, which is led through the heating device disposed below the beverage container 305 and flows into an outlet connection 370. To the outlet in the beverage container 305, a non-return valve—not represented, is associated which can be actuated by the control device 4 in order to facilitate a draining of the hot beverage after completion of the hot beverage, from the beverage container 305 into the product container 371 which is particularly configured as a thermal vessel. By this, it can be ensured that a contact between the hot beverage and the beverage substrate can be prevented after a predefined preparation time.

The hot beverage preparation device 401 represented in the FIGS. 6 and 7 is distinguished from the above described embodiments by using a heating device 403 configured as induction cooking plate and by a beverage container 405 customized to this heating device 403, which is manufactured from a material with ferromagnetic portion. Further, the stirring device 406 is configured rigid, because the housing 480 is divided in a lower housing 482 and an upper housing 481, which are connected by a telescopic device 483. The telescopic device 483 can be equipped with the passive, for example—with a gas spring, or an active, for example—with an electrical spindle drive, facilitates a simple removal of the upper housing 481 from the lower housing 482, by which the stirring device 406 can be pulled out of the beverage container 405. As a result, the beverage container 405 can be removed from the heating device 403 in a simple manner.

Preferably, the stirrer 430 is configured removeable from the motor shaft 433 of the electrical drive motor—not represented, integrated in the upper housing 481, in order to facilitate the cleaning of the stirrer, for example, in a washing machine. The stirrer blade 435 of the stirrer 430 is preferably configured such that during a rotational movement about the axis of rotation 434 in a first rotational direction, it facilitates an advantageous intermixing of the hot beverage accommodated in the beverage container 405. During a rotational movement of the stirrer 430 about the axis of rotation 434 into a second which is opposite to the first rotational direction, a higher input of ambient air is facilitated into the hot beverage accommodated in the beverage container 405, in order to obtain a quick cooling, particularly before carrying out the next heating cycle for the hot beverage and/or an improved extraction of the flavoring agents and ingredients. The stirrer blades 435 are introduced as a base body 486 on a strainer-like configured and with this, serving as filtering device, in which the beverage substrate, particularly with removed stirrer 430, can be filled, so that this reaches during the process of preparation of the hot beverage in intensive exchange with the liquid and however is restrained from the liquid.

A liquid level sensor 423, an excessive foaming sensor 484 and a temperature sensor 485 are disposed on the stirrer 430, are in an electrical connection—not represented in more details, with a control device disposed in the beverage container 405, particularly in the upper housing 481, likewise not represented in more details.

By means of the liquid sensor 423, it can be determined before the hot beverage preparation whether there is enough liquid in the beverage container 405 for carrying out the hot beverage preparation. Should this not be the case, it can be provided that the hot beverage preparation device 401 issues a warning signal and/or that the process of hot beverage preparation is not proceeded further.

By means of the excessive foaming sensor 484, it can be determined before the process of hot beverage preparation whether possibly too much liquid is present in the hot beverage container 405 for carrying out the hot beverage preparation. Should this not be the case, a warning signal can be issued in order to prompt the user to a reduction of the liquid level. Should the liquid level before the start of the hot beverage preparation remains in the interval determined by both the sensors 423 and 484, the hot beverage preparation can be started. For this purpose, the hot beverage preparation device 403 is applied with electrical energy and the stirrer 430 rotates in the first rotational direction about the axis of rotation 434. This takes place until a first target temperature for the first hot beverage preparation process was obtained by means of the temperature sensor 485, which is maintained by corresponding regulation of the heating device 405 403 over a predeterminable time interval.

Should during this heating cycle, particularly on reaching the boiling temperature of the hot beverage, foam should form on the surface of the hot beverage or the liquid level should rise for other reasons, so that a level predeterminable in the beverage container 405 by the excessive foaming sensor 484 is exceeded, counter measures against an excessive foaming can be provided. These counter measures may include, for example, increasing the rotational speed of the stirrer 430 and/or reducing the energy supply to the heating device 403.

After termination of the heating cycle, a cooling cycle takes place for the hot beverage, during which it can be provided that the stirrer 430 is rotated in the second rotational direction about the axis of rotation 434, in order to obtain an input of the ambient air into the hot beverage and with this, a quick cooling to a second target temperature, which remains below the first target temperature. A complete switching-off of the heating device 403 can be provided for the cooling. If necessary, on approaching the second target temperature, an intermittent energy supply to the heating device 403 may be undertaken, should the second target temperature be retained over a longer time period.

Subsequently, a reheating of the hot beverage to the first target temperature takes place, wherein the stirrer 430 is again rotated in the first rotational direction. There can be a further cooling phase associated with or without rotation of the stirrer 430. If necessary, still further heating- and cooling cycles with the same or different durations and/or same or different first and second target temperatures. Preferably, three heating cycles are provided, respectively with the same first target temperature, which correspond to the boiling temperature of the hot beverage, and two cooling cycles lying between them on respectively the same second target temperature.

### CITATIONS CONTAINED IN THE DESCRIPTION

This list of the document submitted by the applicant was automatically generated and is incorporated exclusively for better information of the reader. The list is not a constituent of the German Patent or Utility Model application. The DPMA undertakes no responsibility for any error or omissions.

Cited Patent Literature

DE 202006016849 U1 [0002]

1-14. (canceled)

15. A beverage preparation device comprising:
a heating device for heating of a first liquid;
a control device for actuating said heating device;
a beverage container configured for accommodating said first liquid, said beverage container having a stirring unit configured for a stirring movement of said first liquid to facilitate a homogeneous distribution of a beverage substrate introduced in said first liquid; and
a storage container for said first liquid, said storage container being disposed in a housing;
wherein said stifling device comprising a filtering device for accommodating said beverage substrate.

16. The beverage preparation device according to claim 15, wherein said stirring device comprises a driving device disposed outside said beverage container and coupled with said control device.

17. The beverage preparation device according to claim 16, wherein said stirring device comprises a telescopic shaft section connected to said driving device which is configured for a height adjustment of a stirring means disposed in said beverage container.

18. The beverage preparation device according to claim 16, wherein said stirring device comprises a coupling device configured for a contactless power transmission between said driving device and a stirring means disposed in said beverage container.

19. The beverage preparation device according to claim 16, wherein said filtering device is configured to be liquid permeable at least in sections, said filtering device is disposed in said beverage container, which is configured such that said filtering device has a restraining function for said beverage substrate and facilitates a distribution of at least one flavoring agent of said beverage substrate in said first liquid.

20. The beverage preparation device according to claim 19, wherein said stirring means is configured as a receptor for said filtering device realized to be removable.

21. The beverage preparation device according to claim 19, wherein said filtering device is integrated in said stirring means.

22. The beverage preparation device according to claim 19, wherein said filtering device comprises a filling opening for feeding said beverage substrate, said filling opening is disposed above a predeterminable maximum liquid level of said beverage container in order to facilitate feeding of said beverage substrate during a process of beverage preparation.

23. The beverage preparation device according to claim 22, wherein said control device is arranged such that the heating of said first liquid in said beverage container takes place by means of a predeterminable temperature profile.

24. The beverage preparation device according to claim 22, wherein said control device is arranged such that the operation of said stifling device takes place depending on one of the feed of said first liquid, the temperature of said first liquid, and the filling level of said first liquid.

25. The beverage preparation device according to claim 22 further comprising a feeding device for a second liquid, said feeding device comprises one of a storage container, a conveying means, and a metering valve, said feeding device is configured for feeding of said second liquid into said beverage container.

26. The beverage preparation device according to claim 25 further comprising a liquid level sensor configured to monitor a liquid level in said beverage container, said liquid level sensor is connected to said control device in order to control one of the feeding of said first liquid, a liquid outflow, a heat supply to said beverage container, and a stifling speed of said stirring device.

27. The beverage preparation device according to claim 26, wherein said liquid level sensor is at least two liquid level sensors linearly spaced apart from each other along an axis of rotation of said stifling device, and wherein a temperature sensor is provided with one of on said stifling device, and in said beverage container.

28. The beverage preparation device according to claim 27 further comprising a product container provided for a prepared beverage, and a connection line configured between said beverage container and said product container for feeding said prepared beverage from said beverage container to said product container wherein said connection line is associated with one of a non-return valve coupled to said control device, and a conveying means coupled to said control device.

29. The beverage preparation device according to claim 28, wherein said control device is configured such that it can perform a sequence of successive heating and cooling cycles with predeterminable cycle duration, and predeterminable target temperatures for said heating cycle and said cooling cycle by means of one of said heating device, and said heating device and said stifling device.

30. A beverage preparation device comprising:
a storage container for storing a first liquid, said storage container being disposed in a housing;
a second storage container for storing a second liquid, said storage container being disposed in said housing;
a heating device in fluid communication with said storage container, said heating device being configured for heating of said first liquid;
a stifling unit receivable in a beverage container and configured for a stirring movement of said first liquid in said beverage container, said stirring movement being configured to facilitate a homogeneous distribution of a beverage substrate introduced in said first liquid;
a control device for actuating said heating device, and said stirring unit;
at least one fluid line for communicating said first fluid from said heating device, and said second fluid from said second storage container to said beverage container; and
a filtering device associated with said stifling device for accommodating said beverage substrate.

31. The beverage preparation device according to claim 30 further comprising a liquid level sensor configured to monitor a liquid level in said beverage container, said liquid level sensor is connected to said control device in order to control one of a feeding of said first liquid, a liquid outflow, a heat supply to said beverage container, and a stirring speed of said stirring device.

32. The beverage preparation device according to claim 30, wherein said stirring device comprises a driving device disposed outside said beverage container and coupled with said control device.

33. The beverage preparation device according to claim 32, wherein said stirring device comprises a telescopic shaft section connected to said driving device which is configured for a height adjustment of a stirring means disposed in said beverage container.

34. The beverage preparation device according to claim 32, wherein said stirring device comprises a coupling device configured for a contactless power transmission between said driving device and a stirring means disposed in said beverage container.
